(19) United States
(12) Patent Application Publication
(10) Pub. No.: US 2026/0164513 A1
(43) Pub. Date: Jun. 11, 2026

(54) METHOD FOR CONTROLLING OUTPUT OF ELECTRIC STOVE AND ELECTRIC STOVE PERFORMING SAME

(71) Applicant: COWAY CO., LTD., Gongju-si (KR)

(72) Inventors: Young Kook KIM, Seoul (KR); Yeon Soo SEONG, Seoul (KR); Young Min KIM, Seoul (KR); Sang Il CHOI, Seoul (KR); Dong Hyun KIM, Seoul (KR); Eui Soon LEE, Seoul (KR); Jun Sang PARK, Seoul (KR); Jae Ho LEE, Seoul (KR)

(73) Assignee: COWAY CO., LTD., Gongju-si (KR)

(21) Appl. No.: 18/709,896

(22) PCT Filed: Nov. 7, 2022
(86) PCT No.: PCT/KR2022/017306

§ 371 Date: May 14, 2024

(30) Foreign Application Priority Data
Nov. 19, 2021 (KR) 10-2021-0160763

(51) Int. Cl. H05B 6/06; H05B 6/12

(52) U.S. Cl. CPC H05B 6/065; H05B 6/1209; H05B 2213/05

(57) ABSTRACT

A method for controlling the output of an electric stove comprising a plurality of loop coils and a plurality of working coils comprises the steps of: sensing a container on the electric stove by means of at least some of the plurality of loop coils; and controlling the output of each of at least some of the plurality of working coils on the basis of at least one of the number of damped oscillations in each of the at least some of the plurality of loop coils and the output intensity of each of at least some working coils corresponding to the at least some of the plurality of loop coils, from among the plurality of working coils.

### TECHNICAL FIELD

The present disclosure relates to a method for controlling the output of an electric stove and an electric stove performing the same.

### BACKGROUND ART

An electric stove is a cooking appliance that cooks food using an electric heater or a separate burner as a heat source, and is classified into an induction heater which uses induction heating and a radiant heater which uses electric resistance according to the method of heating.

As electric power is applied to the induction heater, a high-frequency voltage of a certain magnitude is applied to a working coil, generating a magnetic field around the working coil. Magnetic lines in the generated induction magnetic field generate an eddy current inside the burner, and the burner is heated by the eddy current.

In the case of the radiant heater, when a certain power is applied to a heating coil inside the burner, the heating coil emits high-temperature radiant heat by generating heat on its own, thus achieving cooking.

Such an electric stove usually comes with a plurality of burners, and is used as a hybrid type that allows a user to choose an appropriate burner depending on the type, amount, use, etc. of food cooked, by differently setting the output power of each burner.

That is, Korean Laid-Open Patent Publication No. 10-2014-0086497 by the present applicant, titled “A method for controlling heating of an induction range” (Patent Document 1), discloses a method for controlling the output of a burner in an induction range. In Patent Document 1, a plurality of coils are installed at a single burner, and each coil may be turned on or off based on a current flowing through each of the plurality of coils installed at a single burner.

However, Patent Document 1 relates to a method for performing the output of a single burner in an induction range in which the positions of burners are fixed, which is hardly applicable to a full-free electric stove in which the positions of burners are not specified. The full-free electric stove is an electric stove in which a plurality of working coils for producing output are uniformly arranged so that a container can be placed and heated anywhere on the electric stove, in order to improve user convenience. This electric stove requires proper control of the output of each of the plurality of working coils corresponding to the position of a container.

Besides, Patent Document 1 relates to a general method of controlling the output of a burner in an induction range, which is hardly applicable if the method involves cooking rice using a pot on an electric stove and controlling the output of a burner depending on how the rice cooking process progresses.

Accordingly, for a rice cooking process on a full-free electric stove, there is a need to propose an algorithm by which a container is heated depending on the progress of the rice cooking process and where the container is placed.

### PRIOR ART DOCUMENT

(Patent Document) Korean Laid-Open Patent Publication No. 10-2014-0086497 (filed on July 8, 2014).

### DETAILED DESCRIPTION OF INVENTION

### Technical Problems

The present disclosure has been made in an effort to provide a method in which the output of each of a plurality of working coils over which a container is placed is controlled differently, in a full-free electric stove capable of sensing and heating a container no matter where it is positioned on the electric stove.

Another aspect of the present disclosure is to provide a method of controlling each of a plurality of working coils when performing a rice cooking process on a full-free electric stove.

Technical objects to be achieved by the present disclosure are not limited to the aforementioned technical objects, and other technical objects not described above may be evidently understood by a person having ordinary skill in the art to which the present disclosure pertains from the following description.

### Technical Solution

In accordance with an embodiment of the present disclosure, there is provided a method for controlling the output of an electric stove including a plurality of loop coils and a plurality of working coils, the method including: sensing a container on the electric stove using at least some of the plurality of loop coils; and controlling an output of each of at least some of the plurality of working coils corresponding to the at least some of the plurality of loop coils based on at least one of the number of damping oscillations in each of the at least some of the plurality of loop coils and an output intensity of each of the at least some of the plurality of working coils.

The controlling of the output of each of the at least some of the plurality of working coils may include: determining a first area where the container is disposed on a first working coil corresponding to a first loop coil whose number of damping oscillations is greater among the at least some of the plurality of loop coils and a second area where the container is disposed on a second working coil corresponding to a second loop coil whose number of damping oscillations is smaller among the at least some of the plurality of loop coils; and controlling the outputs of the first working coil and the second working coil based on the first area and the second area.

When the number of damping oscillations in the first loop coil is greater than the number of damping oscillations in the second loop coil, the first area may be determined to be larger than the second area.

The controlling of the output of each of the at least some of the plurality of working coils may include: determining a first area where the container is disposed on a first working coil whose output intensity is larger among the at least some of the plurality of working coils, and a second area where the container is disposed on a second working coil whose output intensity is smaller among the at least some of the plurality of working coils; and controlling the outputs of the first working coil and the second working coil based on the first area and the second area.

When the output intensity of the first working coil is higher than the output intensity of the second working coil, the first area may be determined to be larger than the second area.

The controlling of the outputs of the first working coil and the second working coil may include controlling the first working coil and the second working coil such that, when the first area is larger than the second area, a first output intensity of the first working coil is higher than a second output intensity of the second working coil.

The controlling of the outputs of the first working coil and the second working coil may include controlling the first working coil and the second working coil such that, when the first area is larger than the second area, a first output time period of the first working coil is shorter than a second output time period of the second working coil.

In the controlling of the first working coil and the second working coil, the first working coil and the second working coil may be operated alternately for the first output time period and the second output time period, respectively.

When the electric stove performs a rice cooking process, the controlling of the output of each of the at least some of the plurality of working coils may be performed in a boiling period of the rice cooking process.

The method may further include controlling each of the at least some of the working coils to have the same output intensity in a heating period of the rice cooking process.

In accordance with another embodiment of the present disclosure, there is provided an electric stove including: a plurality of loop coils; a plurality of working coils; and an output control device that senses a container using at least some of the plurality of loop coils and controls an output of each of at least some of the plurality of working coils corresponding to the at least some of the plurality of loop coils based on at least one of the number of damping oscillations in each of the at least some of the plurality of loop coils and an output intensity of each of the at least some of the plurality of working coils.

The output control device may control a first working coil and a second working coil such that, when an area where the container is disposed on the first working coil is larger than an area the container is disposed on the second working coil, a first output intensity of the first working coil is higher than a second output intensity of the second working coil.

The output control device may control a first working coil and a second working coil such that, when an area where the container is disposed on the first working coil is larger than an area where the container is disposed on the second working coil, a first output time period of the first working coil is shorter than a second output time period of the second working coil.

### Effect of Invention

According to an embodiment of the present disclosure, it is possible to heat a container with an optimum output for a cooking process used on the container, by differently controlling the output of each of a plurality of working coils over which the container is placed, in a full-free electric stove capable of sensing and heating a container no matter where it is positioned on the electric stove.

According to an embodiment of the present disclosure, it is possible to reduce noise caused by operation of a full-free electric stove, by allowing a plurality of working coils with different operating frequencies to operate alternately in the electric stove.

According to an embodiment of the present disclosure, it is possible to control the output of a plurality of working coils based on the area the container occupies over each of the working coils during a boiling period when a rice cooking process is performed on a full-free electric stove, thereby providing better rice cooking performance in the boiling period with less moisture.

### BRIEF DESCRIPTION OF THE DRAWINGS

FIG. 1 is a block diagram of an electric stove according to an embodiment of the present disclosure.

FIG. 2 shows an example in which a plurality of working coils and a plurality of loop coils are disposed.

FIG. 3 is a block diagram conceptually showing functions of an output control program according to the embodiment of the present disclosure.

FIG. 4 shows an example in which a container on an electric stove is sensed.

FIG. 5 shows another example in which a container on an electric stove is sensed.

FIG. 6 shows a relationship between the output intensity and output time of each of two or more working coils over which a container is positioned.

FIG. 7 is a flowchart illustrating a method of controlling the output of an electric stove by an output control program according to the embodiment of the present disclosure.

### BEST MODE FOR CARRYING OUT THE INVENTION

Advantages and features of the present disclosure and methods for achieving them will be made clear from embodiments described below in detail with reference to the accompanying drawings. The present disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. The present disclosure is merely defined by the scope of the claims.

In describing embodiments of the present disclosure, a detailed description of known functions or configurations related to the present disclosure will be omitted when it is deemed that they may unnecessarily obscure the subject matter of the present disclosure. The terms as used herein are defined considering the functions in the disclosure and may be replaced with other terms according to the intention or practice of the user or operator. Therefore, the terms should be defined based on the overall disclosure.

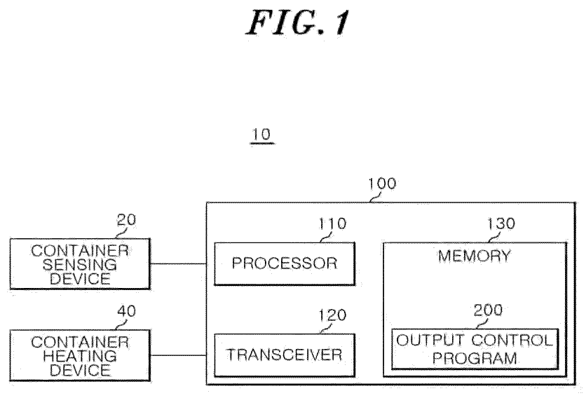

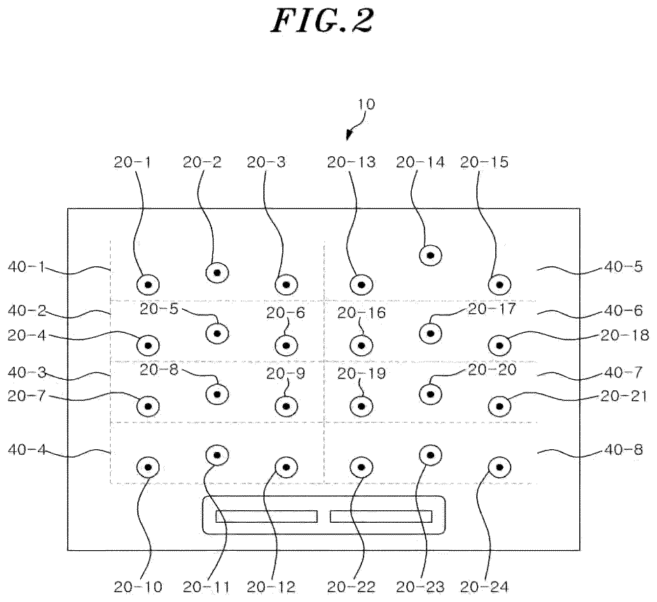

FIG. 1 is a block diagram of an electric stove according to an embodiment of the present disclosure. FIG. 2 shows an example in which a plurality of working coils and a plurality of loop coils are disposed.

Referring to FIG. 1, the electric stove 10 may include a container sensing device 20, a container heating device 40, and an output control device 100.

The electric stove 10 may heat a container in which food is contained, in order to cook the food.

In some embodiments, the electric stove 10 may be a full-free electric stove. Unlike conventional electric stoves in which burners are present in some part of the cooktop and a container can be placed only at fixed positions, the full-free electric stove is a type of electric stove in which the entire cooktop of the electric stove can work as a burner. The full-free electric stove may refer to an electric stove capable of sensing a container and heating the sensed container, no matter where on the cooktop the container is placed.

The container sensing device 20 may be provided to sense a container positioned on the electric stove 10.

In some embodiments, the container sensing device 20 may include a plurality of loop coils, and may sense where on the cooktop of the electric stove 10 a container is placed, by using the plurality of loop coils. That is, if the electric stove 10 is a full-free electric stove, the container sensing device 20 may include a plurality of loop coils so as to sense a container no matter where on the cooktop of the electric stove 10 the container is placed, and may sense where on the electric stove 10 the container is placed, by using at least some of the plurality of loop coils.

For example, if the electric stove 10 is turned on, the container sensing device 20 may apply an electrical current simultaneously or sequentially to the plurality of loop coils, and if the number of damping oscillations in some of the loop coils, caused by the applied electric current, is equal to or greater than a preset reference value, it may be determined that the container is positioned over those loop coils.

To this end, the plurality of loop coils may or may not be arranged at equal intervals under the cooktop of the electric stove 10.

The container heating device 40 may be provided to heat a container sensed by the container sensing device 20.

In some embodiments, the container heating device 40 may include a plurality of working coils, and may heat a container placed on the cooktop of the electric stove 10 by using the plurality of working coils. That is, if the electric stove 10 is a full-free electric stove, the container heating device 40 may include a plurality of working coils to heat a container no matter where on the cooktop of the electric stove 10 the container is placed, and may heat the container placed on the electric stove 10 by using at least some of the plurality of working coils.

To this end, the plurality of working coils may or may not be arranged in areas into which a portion of the cooktop of the electric stove 10 where a container can be placed is equally divided.

In some embodiments, each of the plurality of loop coils may correspond to one of the plurality of working coils. That is, if the container sensing device 20 senses a container by using some of the plurality of loop coils, the container heating device 40 may heat the container by using some working coils corresponding to those loop coils, from among the plurality of working coils.

For example, referring further to FIG. 2, the temperature sensing device 20 may include twenty-four loop coils 20-1 to 20-24, and the container heating device 40 may include eight working coils 40-1 to 40-8. In this case, each of the twenty-four loop coils 20-1 to 20-24 may correspond to one of the eight working coils 40-1 to 40-8.

That is, as shown in FIG. 2, the first loop coil 20-1, the second loop coil 20-2, and the third loop coil 20-3 may correspond to the first working coil 40-1, the fourth loop coil 20-4, the fifth lop coil 20-5, and the sixth loop coil 20-6 may correspond to the second working coil 40-2, the seventh loop coil 20-7, the eighth loop coil 20-8, and the ninth loop coil 20-9 may correspond to the third working coil 40-3, the tenth loop coil 20-10, the eleventh loop coil 20-11, and the twelfth loop coil 20-12 may correspond to the fourth working coil 40-4, the thirteenth loop coil 20-13, the fourteenth loop coil 20-14, and the fifteenth loop coil 20-15 may correspond to the fifth working coil 40-5, the sixteenth loop coil 20-16, the seventeenth loop coil 20-17, and the eighteenth loop coil 20-18 may correspond to the sixth working coil 40-6, the nineteenth loop coil 20-19, the twentieth loop coil 20-20, and the twenty-first loop coil 20-21 may correspond to the seventh working coil 40-7, and the twenty-second loop coil 20-22, the twenty-third loop coil 20-23, and the twenty-fourth loop coil 20-24 may correspond to the eighth working coil 40-8.

Accordingly, for example, if the first loop coil 20-1, the second loop coil 20-2, the fourth loop coil 20-4, and the fifth loop coil 20-5 sense a container on the electric stove 10, the container heating device 40 may heat the container by controlling the output of the first working coil 40-1 corresponding to the first loop coil 20-1 and the second loop coil 20-2 and the output of the second working coil 40-2 corresponding to the fourth loop coil 20-4 and the fifth loop coil 20-5.

Referring back to FIG. 1, the output control device 100 may sense a container on the electric stove 10 by using at least some of the plurality of loop coils included in the container sensing device 20, and may control the output of each of at least some working coils corresponding to the at least some loop coils having sensed the container, from among the plurality of working coils, based on the area the container occupies over each of the at least some working coils.

More specifically, the output control device 100 may determine the area the container occupies over each of the at least some working coils on the basis of at least one of the number of damped oscillations in each of the at least some loop coils and the output intensity of each of the at least some working coils, and may control the output of each of the at least some working coils based on the above area.

For example, in a case where the electric stove 10 performs a rice cooking process according to a user's request, the output control device 100 may determine the area the container occupies over each of the at least some working coils during a boiling period in the rice cooking process, on the basis of at least one of the number of damped oscillations in each of the at least some loop coils and the output intensity of each of the at least some working coils, and may control the output of each of the at least some working coils based on the above area.

In the present specification, the rice cooking process is a process in which rice contained in a container placed on the electric stove 10 is cooked according to the user's request, which refers to a process of adjusting the output of some of the plurality of working coils where the container is positioned according to a preset process, so that the rice contained in the container is cooked, and which may include a heating period and a boiling period.

Here, the heating period is a period in which the temperature in the container is increased by applying high output power to the container, during which the output of the electric stove 10 may be preset so as to increase the temperature in the container. Further, the boiling period is a period in which the rice in the container swells and keeps boiling, during which the output of the electric stove 10 may be preset so as to keep the temperature in the container constant during the boiling period.

To this end, the output control device 100 may include a processor 110, a transceiver 120, and a memory 130.

The processor 110 may control the overall operation of the output control device 100.

The processor 110 may receive the number of damped oscillations in each of the plurality of loop coils from the container sensing device 20, by using the transceiver 120, and may receive the output of each of the plurality of working coils from the container heating device 40.

The memory 130 may store an output control program 200 and information required to execute the output control program 200.

In the present specification, the output control program 200 may refer to software including instructions programmed to control the output of the plurality of working coils based on the area the container occupies over each of the plurality of working coils.

The processor 110 may load the output control program 200 and the information required to execute the output control program 200 from the memory 130, in order to execute the output control program 200.

The processor 110 may execute the output control program 200 to sense a container on the electric stove 10 by using at least some of the plurality of loop coils included in the container sensing device 20, and may determine the area the container occupies over each of at least some working coils corresponding to the at least some loop coils, from among the plurality of working coils, on the basis of at least one of the number of damped oscillations in each of the at least some loop coils and the output intensity of each of the at least some working coils, and may control the output of each of the at least some working coils based on the above area.

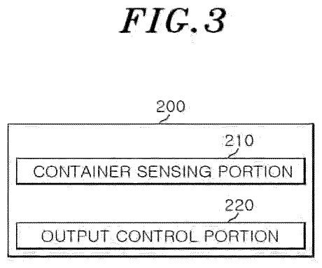

Functions and/or operation of the output control program 200 will be described in detail with reference to FIG. 3.

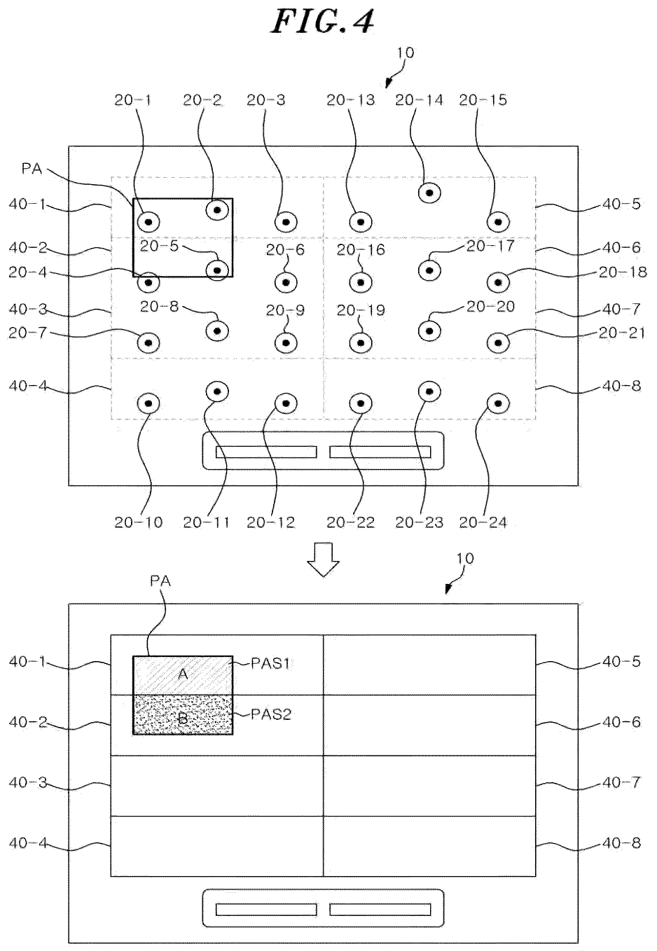

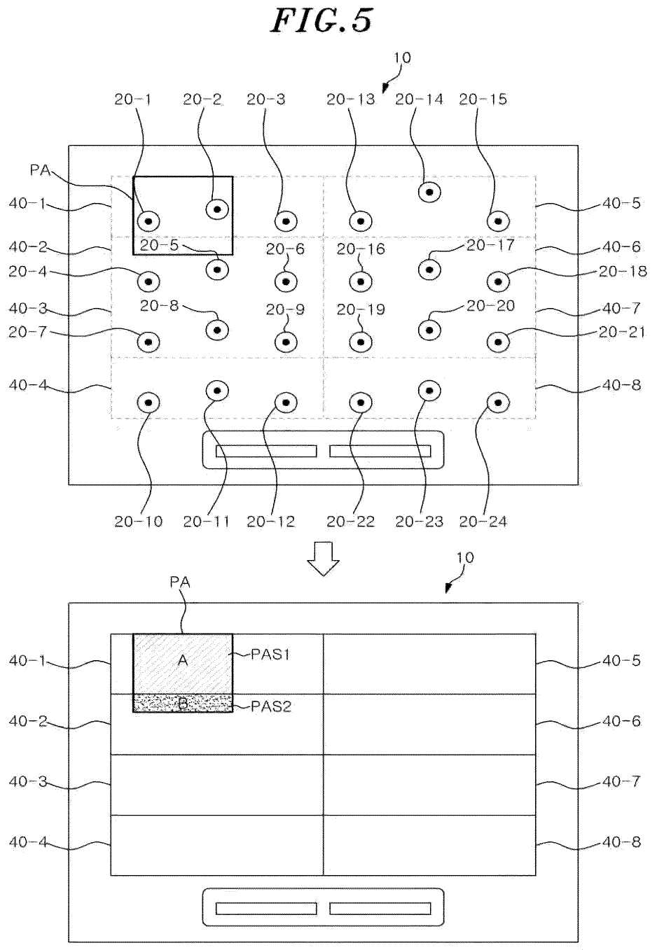

FIG. 3 is a block diagram conceptually showing functions of an output control program according to the embodiment of the present disclosure. FIG. 4 shows an example in which a container on an electric stove is sensed. FIG. 5 shows another example in which a container on an electric stove is sensed.

Referring to FIGS. 1, 2, and 3, the output control program 200 may include a container sensing portion 210 and an output control portion 220.

The container sensing portion 210 and output control portion 220 illustrated in FIG. 3 are functional units into which the functionality of the output control program 200 is conceptually divided for ease of explanation of the functionality of the output control program 200, but they are not limited to this. In some embodiments, the functions of the container sensing portion 210 and the output control portion 220 may be combined/separated, and may be implemented by a series of instructions included in one program.

The container sensing portion 210 may sense a container on the electric stove 10 by using the plurality of loop coils 20-1 to 20-24 included in the container sensing device 20.

More specifically, the container sensing portion 210 may sense whether a container is positioned on the electric stove 10, based on the number of damped oscillations in each of the plurality of loop coils 20-1 to 20-24, and determine the identity of the sensed container based on the positions of the loop coils having sensed the container.

In some embodiments, the container sensing portion 210 may apply an electric current simultaneously or sequentially to the plurality of loop coils 20-1 to 20-24 included in the container sensing device 20, and if there is a loop coil, among the plurality of loop coils 20-1 to 20-24, whose number of damped oscillations caused by the applied electric current is equal to or greater than preset reference value, may determine that a container is positioned on that loop coil.

In this case, if the loop coils having sensed the container are adjacent to one another, the container sensing portion 210 may determine that the containers sensed by the adjacent loop coils are identical (i.e., the same container has been sensed).

For example, referring further to FIG. 4, if the number of damped oscillations caused by an electric current applied to each of the first loop coil 20-1, the second loop coil 20-2, and the fifth loop coil 20-5, among the plurality of loop coils 20-1 to 20-24, is equal to or greater than a preset reference value, the container sensing portion 210 may determine that the container PA is positioned on the first loop coil 20-1, the second loop coil 20-2, and the fifth loop coil 20-5. Also, since the first loop coil 20-1, the second loop coil 20-2, and the fifth loop coil 20-5 are adjacent to one another, the container sensing portion 210 may determine that the first loop coil 20-1, the second loop coil 20-2, and the fifth loop coil 20-5 have sensed the same single container.

Moreover, referring further to FIG. 5, if the number of damped oscillations caused by an electric current applied to each of the first loop coil 20-1 and the second loop coil 20-2, among the plurality of loop coils 20-1 to 20-24, is equal to or greater than a preset reference value, the container sensing portion 210 may determine that the container PA is positioned on the first loop coil 20-1 and the second loop coil 20-2. Since the first loop coil 20-1 and the second loop coil 20-2 are adjacent to one another, the container sensing portion 210 may determine that the first loop coil 20-1 and the second loop coil 20-2 have sensed the same single container.

Referring back to FIG. 3, the output control portion 220 may control the output of each of at least some working coils corresponding to the at least some loop coils having sensed the container, from among the plurality of working coils 40-1 to 40-8, based on the area the container occupies over each of the at least some of the working coils.

More specifically, the output control portion 220 may determine the area the container occupies over each of the at least some working coils on the basis of at least one of the number of damped oscillations in each of the at least some loop coils and the output intensity of each of the at least some working coils, and may control the output of each of the at least some working coils based on the above area.

To this end, the output control portion 220 may measure output intensity by applying an electric current to the working coils corresponding to the loop coils having not sensed the container, as well as to the working coils corresponding to the loop coils having sensed the container, among the plurality of working coils. This is because, even if the container is positioned on a working coil, the loop coils corresponding to that working coil may not be able to sense the container depending on the position of the container.

In some embodiments, if the difference in the number of damped oscillations between each of the at least some of the plurality of loop coils is equal to or greater than a preset reference value, the output control portion 220 may determine that the area the container occupies over a working coil corresponding to a loop coil whose number of damped oscillations is greater, among the at least some of the plurality of loop coils, is larger than the area the container occupies over a working coil corresponding to a loop coil whose number of damped oscillations is smaller, among the at least some of the plurality of loop coils.

Moreover, in some embodiments, if the difference in output intensity between each of the at least some of the plurality of working coils is larger than (exceeds) a preset reference value, the area the container occupies over a working coil whose output intensity is larger, among the at least some of the plurality of working coils, is larger than the area the container occupies over a working coil whose output intensity is smaller, among the at least some of the plurality of working coils.

For example, referring back to FIG. 4, when a container has been sensed by using the first loop coil 20-1, the second loop coil 20-2, and the fifth loop coil 20-5, if the difference in the number of damped oscillations among the first loop coil 20-1, the second loop coil 20-2, and the fifth loop coil 20-5 is smaller than (below) a reference value, or if the difference between the output intensity of the first working coil 40-1 corresponding to the first loop coil 20-1 and the second loop coil 20-2 and the output intensity of the second working coil 40-2 corresponding to the fifth loop coil 20-5 is smaller than a predetermined value, the output control portion 220 may determine that a first area PAS1 the container PA occupies over the first working coil 40-1 and a second area PAS2 the container occupies over the second working coil 40-2 are identical.

On the other hand, referring back to FIG. 5, when a container has been sensed by using the first loop coil 20-1 and the second loop coil 20-2, if the difference between the output of the first working coil 40-1 and the second working coil 40-2 adjacent to the first working coil 40-1 is equal to or greater than a predetermined value, the output control portion 220 may determine that the first area PAS1 in which the container PA occupies over the first working coil 40-1 and the second area PAS2 in which the container PA occupies over the second working coil 40-2 are not identical.

In some embodiments, the output control portion 220 may determine the area the container occupies over each of the at least some of the working coils during a boiling period in the rice cooking process, on the basis of at least one of the number of damped oscillations in each of the at least some loop coils and the output intensity of each of the at least some working coils, and may control the output of each of the at least some working coils based on the above area.

That is, the output of a working coil may vary with the area the container occupies over the working coil. In a heating period of the rice cooking process, there is sufficient water in the container, and therefore heat may circulate within the container through the water even if the output is not controlled differently for each working coil (that is, even if each working coil has the same output). On the other hand, in a boiling period of the rice cooking process, there is insufficient water in the container, and therefore the content at a portion of the container under which a higher-output working coil is positioned may be scorched, and the content at a portion of the container under which a lower-output working coil is positioned may be undercooked. Thus, the output control portion 220 may control the output of each of at least some working coils during the boiling period, based on the area the container occupies over each of the at least some working coils.

Afterwards, the output control portion 220 may control the output of each of at least some working coils that have detected the same container, based on the area the container occupies over each of the at least some working coils.

This is because, if the container is positioned over two or more working coils, the content at a portion of the container under which a higher-output working coil is positioned may be scorched, and the content at a portion of the container under which a lower-output working coil is positioned may be undercooked, depending on the content in the container or the type of cooking process.

Accordingly, in order to overcome this problem, if the container is positioned over two or more working coils, the output control portion 220 may heat the container in such a way that a higher-output working coil produces higher output power and a lower-output working coil produces lower output power. In this instance, the output time of the higher-output working coil may be set to be shorter than the output time of the lower-output working coil, in order to match the total output of each working coil.

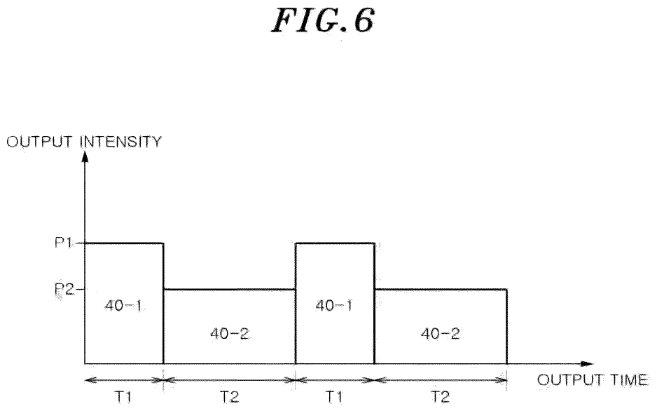

For example, FIG. 6 shows a relationship between the output intensity and output time of each of two or more working coils over which a container is positioned.

Referring further to FIGS. 5 and 6, since the area PAS1 the container PA occupies over the first working coil 40-1 is larger than the second area PAS2 the container PA occupies over the second working coil 40-2, a first output P1 of the first working coil 40-1 may be larger than a second output P2 of the second working coil 40-2.

In this case, the output control portion 220 may set a first output time T1 of the first working coil 40-1 to be shorter than a second output time T2 of the second working coil 40-2, in order to meet the total output of the first working coil 40-1 and the total output of the second working coil 40-2. More specifically, the output control portion 220 may set the first output time T1 and the second output time T2 such that the product of the first output P1 and the first output time T1 and the product of the second output P2 and the second output time T2 are equal.

Meanwhile, the first working coil 40-1 and the second working coil 40-2 may have different operating frequencies since their areas in contact with the container PA are different.

More specifically, the operating frequency of the first working coil 40-1 with a higher output may be set to be lower than the operating frequency of the second working coil 40-2. When simultaneously operating the first working coil 40-1 and the second working coil 40-2 which have different operating frequencies, their output application times may overlap, which may cause noise.

To solve this problem, when two or more working coils have different areas in contact with the container, the output control portion 220 may allow the two or more working coils to operate alternately. That is, as depicted in FIG. 6, the output control portion 220 may control the first working coil 40-1 and the second working coil 40-2 in such a way that the first working coil 40-1 operates for a first output time T1, then the second working coil 40-2 operates for a second output time T2, and, after completion of the operation of the second working coil 40-2, the first working coil 40-1 operates again for the first output time T1.

Although the above description has been given with respect to two working coils, three or more working coils may be controlled in the same method.

Meanwhile, when the electric stove 10 performs a rice cooking process, the container does not have enough water in a boiling period, unlike in a heating period. Thus, in a case where the container is positioned over two or more working coils, the content at a portion of the container under which a higher-output working coil is positioned may be scorched, and the content at a portion of the container under which a lower-output working coil is positioned may be undercooked.

Accordingly, in the boiling period, if the container is positioned over two or more working coils, the output control portion 220 may heat the container in such a way that a higher-output working coil produces higher output power and a lower-output working coil produces lower output power.

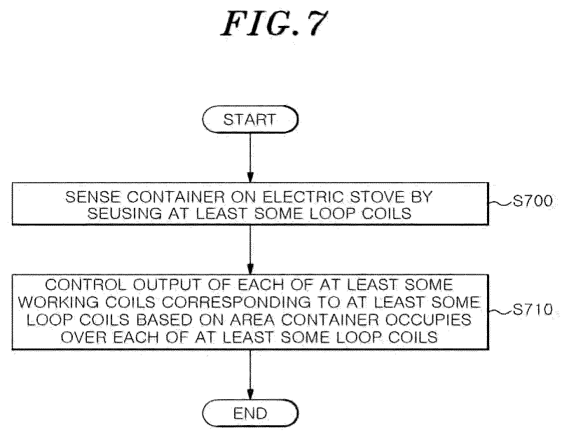

FIG. 7 is a flowchart illustrating a method of controlling the output of an electric stove by an output control program according to the embodiment of the present disclosure.

Referring to FIGS. 1, 2, 3, and 7, the container sensing portion 210 may sense a container on the electric stove 10, by using at least some of the plurality of loop coils 20-1 to 20-24 (S700).

The output control portion 220 may control the output of each of at least some working coils corresponding to the at least some loop coils having sensed the container based on the area the container occupies over each of the at least some working coils (S710).

According to the embodiment of the present disclosure, it is possible to heat a container with an optimum output for a cooking process used on the container, by differently controlling the output of each of a plurality of working coils over which the container is placed, in a full-free electric stove capable of sensing and heating a container no matter where it is positioned on the electric stove.

According to the embodiment of the present disclosure, it is possible to reduce noise caused by operation of a full-free electric stove, by allowing a plurality of working coils with different operating frequencies to operate alternately in the electric stove.

According to the embodiment of the present disclosure, it is possible to control the output of a plurality of working coils based on the area the container occupies over each of the working coils during a boiling period when a rice cooking process is performed in a full-free electric stove, thereby providing better rice cooking performance in the boiling period with less water.

It will be understood that each block of a flowchart in the drawings and combinations of blocks of the flowchart may be performed by computer program instructions. These computer program instructions may be loaded into a processor of a general-purpose computer, a special-purpose computer, or other programmable data processing equipment, and thus, the instructions performed via the processor of the computer or other programmable data processing equipment create a means for performing functions specified in the flowchart block(s). The computer program instructions may also be stored in a computer-executable or computer-readable memory capable of directing the computer or other programmable data processing equipment to implement functions in a specific manner, and thus, the instructions stored in the computer-executable or computer-readable memory may produce an article of manufacture including instruction means for performing the functions described in the flowchart block(s). The computer program instructions may also be loaded into the computer or other programmable data processing equipment, and thus, instructions for operating the computer or the other programmable data processing equipment by generating a computer-executed process when a series of operations are performed in the computer or the other programmable data processing equipment may provide operations for performing the functions described in the flowchart block(s).

In addition, each block may represent a portion of a module, segment, or code that includes one or more executable instructions for executing specified logical function(s). It should also be noted that, in some alternative implementations, functions mentioned in blocks may occur out of order. For example, two blocks illustrated in succession may be executed substantially simultaneously, or the blocks may sometimes be executed in reverse order depending on functions corresponding thereto.

The above description is merely illustrative of the technical idea of the present disclosure, and those skilled in the art to which the present disclosure pertains may make various modifications and changes without departing from the essential quality of the present disclosure. Accordingly, the embodiments disclosed herein are not intended to limit the technical spirit of the present disclosure but to describe the present disclosure, and the scope of the present disclosure is not limited by these embodiments. The scope of protection of the present disclosure should be interpreted by the following claims, and all technical ideas that fall within the scope of equivalents thereof should be construed as being included in the scope of the present disclosure.

1. A method for controlling an output of an electric stove including a plurality of loop coils and a plurality of working coils, the method comprising:
sensing a container on the electric stove using at least some of the plurality of loop coils; and
controlling an output of each of at least some of the plurality of working coils corresponding to the at least some of the plurality of loop coils based on at least one of the number of damping oscillations in each of the at least some of the plurality of loop coils and an output intensity of each of the at least some of the plurality of working coils.

2. The method of claim 1, wherein the controlling of the output of each of the at least some of the plurality of working coils includes:
determining a first area where the container is disposed on a first working coil corresponding to a first loop coil whose number of damping oscillations is greater among the at least some of the plurality of loop coils and a second area where the container is disposed on a second working coil corresponding to a second loop coil whose number of damping oscillations is smaller among the at least some of the plurality of loop coils; and
controlling outputs of the first working coil and the second working coil based on the first area and the second area.

3. The method of claim 2, wherein, when the number of damping oscillations in the first loop coil is greater than the number of damping oscillations in the second loop coil, the first area is determined to be larger than the second area.

4. The method of claim 1, wherein the controlling of the output of each of the at least some of the plurality of working coils includes:
determining a first area where the container is disposed on a first working coil whose output intensity is larger among the at least some of the plurality of working coils, and a second area where the container is disposed on a second working coil whose output intensity is smaller among the at least some of the plurality of working coils; and
controlling outputs of the first working coil and the second working coil based on the first area and the second area.

5. The method of claim 4, wherein, when the output intensity of the first working coil is higher than the output intensity of the second working coil, the first area is determined to be larger than the second area.

6. The method of claim 2, wherein the controlling of the outputs of the first working coil and the second working coil includes controlling the first working coil and the second working coil such that, when the first area is larger than the second area, a first output intensity of the first working coil is higher than a second output intensity of the second working coil.

7. The method of claim 2, wherein the controlling of the outputs of the first working coil and the second working coil includes controlling the first working coil and the second working coil such that, when the first area is larger than the second area, a first output time period of the first working coil is shorter than a second output time period of the second working coil.

8. The method of claim 7, wherein, in the controlling of the first working coil and the second working coil, the first working coil and the second working coil are operated alternately for the first output time period and the second output time period, respectively.

9. The method of claim 1, wherein, when the electric stove performs a rice cooking process, the controlling of the output of each of the at least some of the plurality of working coils is performed in a boiling period of the rice cooking process.

10. The method of claim 9, further comprising controlling each of the at least some of the working coils to have the same output intensity in a heating period of the rice cooking process.

11. An electric stove comprising:
a plurality of loop coils;
a plurality of working coils; and
an output control device that senses a container using at least some of the plurality of loop coils and controls an output of each of at least some of the plurality of working coils corresponding to the at least some of the plurality of loop coils based on at least one of the number of damping oscillations in each of the at least some of the plurality of loop coils and an output intensity of each of the at least some of the plurality of working coils.

12. The electric stove of claim 11, wherein the output control device controls a first working coil and a second working coil such that, when an area where the container is disposed on the first working coil is larger than an area the container is disposed on the second working coil, a first output intensity of the first working coil is higher than a second output intensity of the second working coil.

13. The electric stove of claim 11, wherein the output control device controls a first working coil and a second working coil such that, when an area where the container is disposed on the first working coil is larger than an area where the container is disposed on the second working coil, a first output time period of the first working coil is shorter than a second output time period of the second working coil.

14. The method of claim 4, wherein the controlling of the outputs of the first working coil and the second working coil includes controlling the first working coil and the second working coil such that, when the first area is larger than the second area, a first output intensity of the first working coil is higher than a second output intensity of the second working coil.

15. The method of claim 4, wherein the controlling of the outputs of the first working coil and the second working coil includes controlling the first working coil and the second working coil such that, when the first area is larger than the second area, a first output time period of the first working coil is shorter than a second output time period of the second working coil.
